(19) United States
(12) Patent Application Publication
(10) Pub. No.: US 2008/0057469 A1
(43) Pub. Date: Mar. 6, 2008

(54) Dental Instrument

(75) Inventors: Robert Hayman, Los Angeles, CA (US); Ken Rosenblood, Los Angeles, CA (US)

Correspondence Address: DISCUS DENTAL IMPRESSIONS, INC., 8550 HIGUERA STREET, CULVER CITY, CA, 90232, US

(73) Assignee: Discus Dental, LLC, Culver City, CA (US)

(21) Appl. No.: 11/927,349

(22) Filed: Oct. 29, 2007

Related U.S. Application Data
(63) Continuation of application No. 11/230,710, filed on Sep. 19, 2005.
(60) Provisional application No. 60/612,283, filed on Sep. 21, 2004.
(60) Provisional application No. 60/612,006, filed on Sep. 21, 2004.
(60) Provisional application No. 60/624,833, filed on Nov. 3, 2004.
(60) Provisional application No. 60/624,840, filed on Nov. 3, 2004.

(51) Int. Cl. A61C 1/07

(52) U.S. Cl. 433/118

(57) ABSTRACT

An active dental tool including a vibratory mechanism and a power storage reservoir. The vibratory mechanism includes an electrical motor and an elliptical load. The elliptical load is adapted to be rotated by the motor and to thereby impart an oscillatory motion to a tooth-contacting portion of the dental tool.

### CROSS-REFERENCE TO RELATED APPLICATIONS

This application claims the benefit of U.S. provisional patent applications: Ser. No. 60/612,283 entitled “Dental Tool Having A Durable Coating” filed on Sep. 21, 2004; 60/612,006 entitled “Dental Instruments Having Durable Coatings” filed Sep. 21, 2004; 60/624,833 entitled, “Dental Instrument” filed on Nov. 3, 2004; and 60/624,840 entitled, “Dental Instruments With Stress Relief” filed on Nov. 3, 2004; the contents of all are hereby incorporated by reference.

This application is related to the following U.S. patent applications: 11/______, entitled “Dental Instrument With Stress Relief” to be concurrently filed; and 11/______, entitled “Dental Instruments Having Durable Coatings” to be concurrently filed; the contents of both are hereby incorporated by reference.

### FIELD OF THE INVENTION

The present invention relates to a dental instrument, and more particularly to an active dental instrument.

### BACKGROUND OF THE INVENTION

The presence of nutrients, saliva, air and bacteria in a mouth allows the formation of plaque and tartar films on tooth surfaces. The development of these films can be inhibited by regular brushing and flossing of teeth. It is widely accepted, however, that an effective program of oral hygiene includes periodic cleaning of teeth by a dental professional. This periodic cleaning is effective to reduce and remove the tartar and plaque that tends to accumulate on tooth surfaces despite diligent personal oral hygiene.

Tartar and plaque removal instruments fall into two classes; manual passive instruments, and externally powered active instruments. The passive instruments are generally formed of a hard and substantially rigid material, such as stainless steel. FIG. 1 shows an exemplary passive instrument. The instrument includes a body 10 that is adapted to be used as a handle, and a pick portion 12 and having an end 14 configured as, for example, a point or a blade. In use, the passive instrument is held in the hand of a dental professional and the end 14 is scraped against a surface of a tooth. Passive instruments offer freedom from constraining power supply umbilicals, but require significant time and skill to use effectively.

It has been customary to use externally powered active dental vibratory instruments to carry out certain dental treatments such as scaling of teeth. A typical powered dental vibratory tool includes an elongated outer casing for grasping by hand, a vibratory unit arranged inside the casing to serve as a source of vibration, and a dental vibratory tool such as a scaling tip detachably connected to the vibrator unit. The dental tool performs desired dental treatment such as scaling and root canal reaming.

Some vibrators used in the powered dental vibratory tools belonged to two typical classes according to the principle of operation: electrically powered vibrators and air-driven vibrators using compressed air as a power source.

The electrical vibrators include an electrostrictive or piezoelectric transducer which generates vibration in response to application of an alternating voltage. These can operated in the ultrasonic range so that they are substantially free from audible noise emission. Electrical vibrators may, however, emit electromagnetic waves. Such electromagnetic energy, emitted at frequencies of about 20,000 Hertz can cause problems, such as interference with other electronic equipment.

Air-driven vibrators are free from the electromagnetic interference problems associated with electrical vibrators. However, the frequency used is generally within the audible frequency spectrum. The tools using this type of vibrators also have to be tethered to a compressed air supply.

Therefore, there remains a need for a handheld, electrical powered dental tool having a small vibrator that can vibrate back and forth and/or side to side to effect teeth cleaning without annoying noise or ultrasonic energy.

### SUMMARY OF THE INVENTION

In view of the foregoing, it is desirable to have a dental instrument having the favorable attributes of both manual and externally powered dental instruments. The present invention overcomes the problems associated with the prior art and provides a method and apparatus for removing plaque and tartar from teeth.

The present invention relates to a dental hand tool including an elongated housing having at least a partially hollow interior, a distal end, a proximal end, and extending from and removably connected to at least one of the ends is a dental tip. A portion of the housing serves as a handle for grasping by the dental professional. At least one vibrator module is positioned and may be resiliently supported inside the housing towards one end of the body. The module includes a small motor adapted to rotate an eccentric weight to cause a vibration in the tip. A battery is positioned inside the housing to power the vibrator module to excite the vibratory element. The battery may be disposable or rechargeable.

The present invention further relates to a handheld dental instrument including an elongated housing having a hollow interior, a proximal end, and a distal end having a cone-shaped portion permanently attached or removably attached to it with its wider end, and a dental tip extending from its narrower end. At least a portion of the housing serves as a handle for grasping by the dental professional. The dental tip may be permanently attached or removably attached to the narrower end of cone-shape portion. The cone-shape portion has at least a partially hollow body with a vibrator module positioned and supported inside the hollow portion of the partially hollow body. The module includes a small motor for rotating an eccentric weight to cause a vibration in the tip. A battery is positioned inside the housing to power the vibrator module to excite the vibratory element. The battery may be disposable or rechargeable.

The present invention also provides sets of vibratory dental instruments, each including an elongated housing having a hollow interior, the elongated body having a proximal end and a distal end and extending from and removably connected to at least one of the ends is a dental tip. A portion of the housing of each instrument serves as a handle for grasping by the dental professional, the handles of the sets of instruments having varying diameters designed to be used interchangeably throughout the day.

The dental instrument may also include a cone-shaped portion permanently attached or removably attached to it with its wider end, and a dental tip extending from its narrower end. The dental tip may be permanently attached or removably attached to the narrower end of cone-shape portion. The cone-shape portion has at least a partially hollow body with a vibrator module positioned and supported inside the hollow portion of the partially hollow body. The module includes a small motor adapted to rotate an eccentric weight to cause a vibration in the tip. A battery is positioned inside the housing to power the vibrator module to excite the vibratory element. The battery may be disposable or rechargeable.

In one aspect of the invention, the dental tip is threadably connected to the distal end of the housing.

In another aspect of the invention, there is an axial positioning means for locating said vibrator module against the distal end of the housing.

Also, in one aspect, a dental instrument according to the invention is lightweight and readily manipulated, as compared with a corresponding externally powered instrument.

In yet another aspect, a dental instrument according to the invention is capable of coupling significant energy to a tooth surface without being coupled to a power source by an energy conduit.

In a further aspect of the invention, the housing is closed at the proximal end and the vibrator module is adapted to be supported towards the distal end.

In yet a further aspect of the invention, a tip extends from each end of the housing, both tips being adapted to vibrate during use.

In still a further aspect of the invention, the cone-shaped portion is rotatable wherein such rotation also rotates the dental tip so that the tip may be easily repositioned without being taken out of the patient's mouth.

In yet another aspect of the invention, the housing includes an ergonomically design adapted for releasing stress experienced by the dental professional. Sets of dental instruments with ergonomically designed handle portion may also be made with varying handle diameters.

Further, a collar may also be used in each of the instruments as another form that may enable the tip to be removable. This collar or the cone-shaped portion described above may also be a rotator head, made rotatable wherein such rotation also rotates the dental tip so that the tip may be easily repositioned without being taken out of the patient's mouth.

In addition, each of the instruments described above may also be made with an anti-rotation means for preventing said vibrator module from rotating relative to said housing when said vibratory tool is in use.

Further, the tips may be coated with a flexible and durable coating coated thereon, such that the coated tip can be bent to the desired configuration, is disclosed. The coating includes a diamond-like-carbon (DLC) coating including at least about 5 atomic percent of hydrogen.

In one aspect, the tip may be bent to any desired configuration after coating, such bending action does not substantially affect the integrity of the coating adversely.

These and other advantages and features of the invention will be more readily understood in relation to the following detailed description of the invention, which is provided in conjunction with the accompanying drawings.

### BRIEF DESCRIPTION OF THE DRAWINGS

FIG. 1 shows a conventional passive dental instrument;

FIG. 2 shows an active dental instrument according to one embodiment of the invention;

FIG. 3 shows an active dental instrument according to one embodiment of the invention;

FIG. 3a shows a block diagram illustrating various functional components of a dental instrument according to one embodiment of the invention;

FIG. 4a shows a cutaway view of an active dental instrument according to one embodiment of the invention;

FIGS. 4b-4d show various elliptical loads for an active dental instrument according to respective embodiments of the invention;

FIG. 5 shows a cutaway view of an active dental instrument according to a further embodiment of the invention;

FIG. 6 shows a cutaway view of an active dental instrument including a linear vibration device according to a further embodiment of the invention;

FIG. 7 shows a perspective view of a set of active dental instruments with varying handle diameters;

FIG. 8 shows a perspective view of a set of ergonomically designed active dental instruments with varying diameters;

FIG. 9 shows an active dental instrument with a rotatable tip;

FIG. 10 shows an exploded view of an active instrument having a rotator head; and

FIG. 11 shows a hand grip adapted for fitting onto an active instrument.

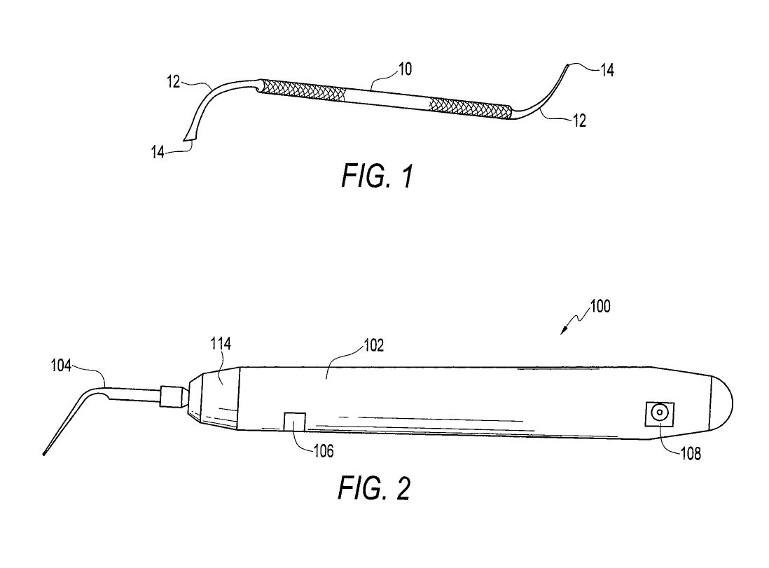

### DETAILED DESCRIPTION OF THE INVENTION

The detailed description set forth below in connection with the appended drawings is intended as a description of the presently exemplified embodiments of dental instruments or tools in accordance with the present invention, and is not intended to represent the only forms in which the present invention may be constructed or utilized. The description sets forth the features and the steps for constructing and using the dental tools or instruments of the present invention in connection with the illustrated embodiments. It is to be understood, however, that the same or equivalent functions and structures may be accomplished by different embodiments that are also intended to be encompassed within the spirit and scope of the invention.

FIG. 2 shows a dental instrument, such as a dental scaler 100, according to a first embodiment of the invention. As shown, the instrument includes a handle portion 102 and a tooth contacting portion 104. In the illustrated embodiment, the tooth contacting portion 104 is a scaler tip. According to one aspect of the invention, a vibrational mechanism is included within the handle portion 102. The vibrational mechanism is adapted to induce motion of the scaler tip 104 with respect to the handle 102, or a portion thereof. The motion of the scaler tip 104 may include a variety of oscillatory modes including flexural and elastic linear modes and torsional modes. According to one embodiment of the invention, the invention includes a switching device 106 supported by the handle portion 102. The switching device 106 allows a user to activate, and deactivate, the vibrational mechanism disposed within the handle portion 102.

According to one embodiment of the invention, an energy port 108, such as a plug receptacle, may also be supported by the handle portion 102. Energy such as electrical energy, maybe received through the energy port and stored within the handle portion 102 of the dental instrument. In the embodiment shown, the energy port is an electrical plug receptacle adapted to receive a conventional electrical plug.

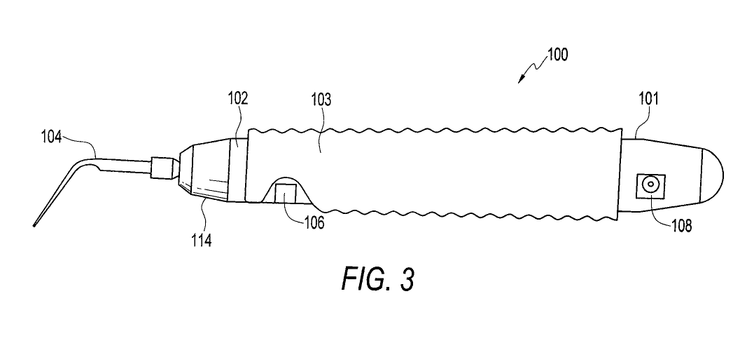

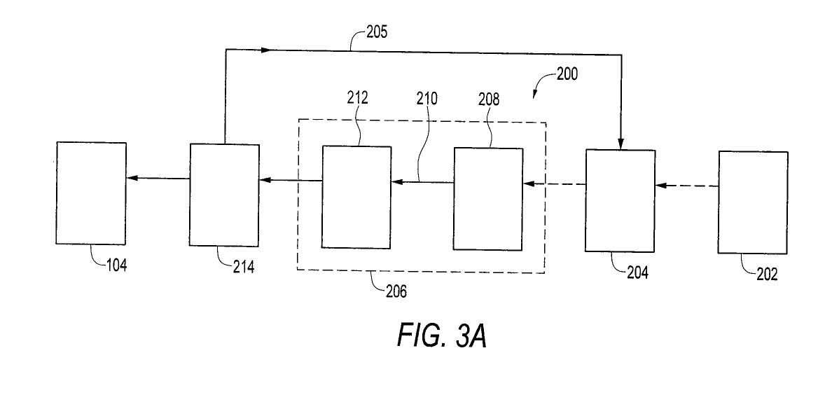

FIG. 3a shows a system block diagram 200 of a dental instrument according to one embodiment of the invention. As shown in FIG. 3, the dental instrument includes a power storage reservoir such as an electrical battery 202. The electrical battery 202 is electrically coupled to a power control device 204. In an exemplary embodiment, the power control device 204 is an electrical switch such as a single pole—single throw switch. In various other embodiments, the power control device 204 may include an active device such as a transistor adapted to provide a variable output voltage in response to an operator signal, or a feedback signal 205. An output of the power control device 204 is electrically coupled to an input of a vibrational transducer 206. According to one embodiment of the invention, the vibrational transducer 206 includes a rotary electric motor 208, such as a permanent magnet DC motor, or a stepper motor. The rotary electric motor 208 is mechanically coupled at an output shaft thereof to a dynamically unbalanced load 212 such as an eccentric flywheel. The rotation of the dynamically unbalanced load 212 by the motor acts to produce a periodic oscillatory force on the shaft of the motor 208. The periodic oscillatory force is transmitted from the shaft of the motor 208 through bearings of the motor to a housing of the motor. From the motor housing, the oscillatory force is transmitted to the housing 102 of the instrument (as shown in FIG. 2).

According to one embodiment of the invention, the vibrational transducer 206 may produce vibrations in a range from about 10 Hz to about 10 KHz. Other frequencies, including harmonics, may be achievable, depending on the characteristics of a particular system.

According to another embodiment of the invention, the vibrational transducer 206 includes a linear motor such as a solenoid, a piezoelectric transducer or a linear stepper motor.

In a further aspect of the invention, the vibrational transducer 206 is mechanically coupled to a first end of a coupling member 214. The coupling member 214 may be a discrete mechanical member, or maybe integral with the housing portion 102 (as shown in FIG. 2).

The coupling member 214 is coupled at a second end to a tooth contacting portion 104. The tooth contacting portion 104 may be, for example, a scaler tip (as shown in FIG. 2).

The dental tip 104 can be a scaler, as shown, or any other adapted to be fitted into a handheld instrument of the present invention, for example, a reamer, an endodontic file, a dental file or bur.

As noted, a dental tip may be present on both the distal end and the proximal end of the instrument (not shown) or it may be present on only one end.

A tapered portion 114, as shown in FIGS. 2, 4a and 9, may be integrally constructed as part of the handle or it may be constructed separately and then by either molding, brazing, threadably connected or any other type of attachment to attach itself to the rest of the handle. The tip may also be permanently or detachably connected to the tapered portion of either the distal or the proximal end of the handle. The tapered portion may further be a cone-shaped portion, for example, with a hollow interior, or at least part of the tapered portion may have a collar, as shown in FIG. 9. The collar may be integrally constructed as part of the handle or it may be constructed separately, by either molding, brazing, threadably connected or any other type of attachment to attach the tip 104 onto either the distal or the proximal end of the handle.

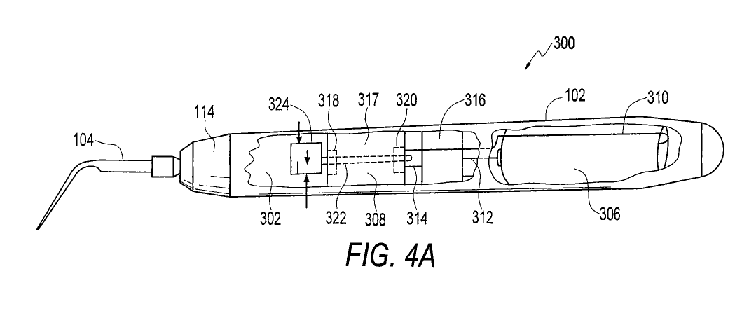

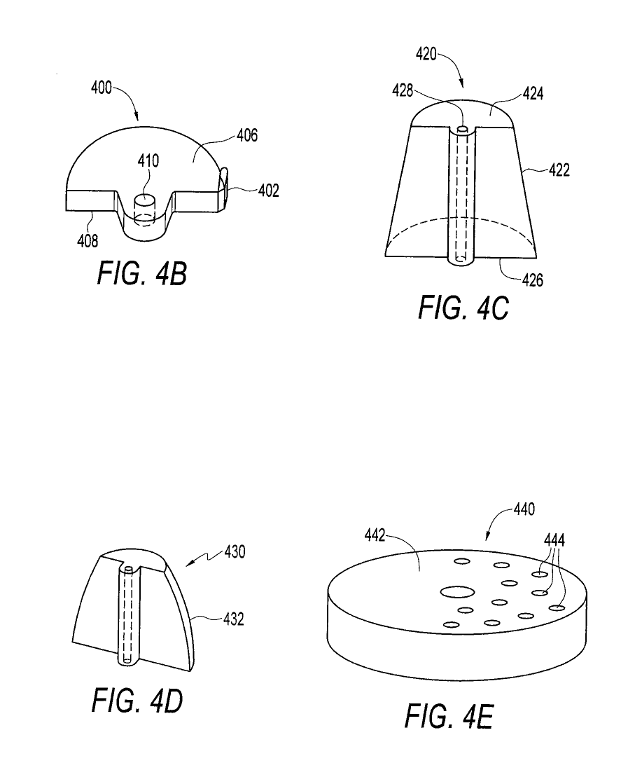

FIG. 4a is a cutaway view of a dental instrument 300 according to one embodiment of the invention. As shown in FIG. 4a, the dental instrument 300 includes a housing 102 and a tooth contacting portion such as a scaler tip 104. According to one embodiment of the invention, the housing 102 includes an internal cavity 302 within which is disposed a battery 306 and an electric motor 308. The battery 306 is electrically coupled to the motor 308 by electrical conductors 310, 312, 314 and a switch 316. According to one embodiment of the invention, the motor 308 may include a housing 317 and first 318 and second 320 bearings. The motor 308 also includes a shaft 322 rotatably supported by the first 318 and second 320 bearings. At one end, the shaft 322 is coupled, to an eccentric load 324.

FIG. 4b shows an eccentric load 400 according to one embodiment of the invention. The eccentric load includes a mass having an arcuate circumferential surface 402 disposed between first 406 and second 408 substantially planar side surfaces. A substantially cylindrical inner surface 410 is disposed between the first and second substantially planar surfaces to define a bore having a longitudinal axis. The longitudinal axis is disposed in substantially parallel spaced relation to an axis of rotation through the center of mass of the eccentric load 400.

In a further embodiment, as shown in FIG. 4c, the eccentric load 420 includes a truncated section of a conical surface 422 disposed between first 424 and second 426 substantially planar side surfaces. A substantially cylindrical inner surface 428 is disposed between the first and second substantially planar surfaces to define a bore having a longitudinal axis. The longitudinal axis is disposed in substantially parallel spaced relation to an axis of rotation through the center of mass of the eccentric load. The resulting conical shape of the FIG. 4c eccentric load 420 is an eccentric load having a mass that diminishes linearly as a function of distance along the motor shaft away from the motor.

In a still further embodiment, as shown in FIG. 4d, the eccentric load 430 includes a truncated section of an ellipsoidal surface 432 disposed between first and second substantially planar side surfaces. The resulting ellipsoidal shape of the FIG. 4d eccentric load 430 results in an eccentric load having a mass that diminishes non-linearly as a function of distance along the motor shaft away from the motor.

In yet another embodiment the elliptical load includes a wheel that is substantially spatially symmetric. However the distribution of mass within the substantially spatially symmetric volume is skewed to produce a dynamically unbalanced load. According to one embodiment, as shown in FIG. 4e, the skewed distribution of mass is produced by forming the wheel 440 of a first material 442 and embedding particles of a second material 444 in a spatially nonuniform distribution within first material.

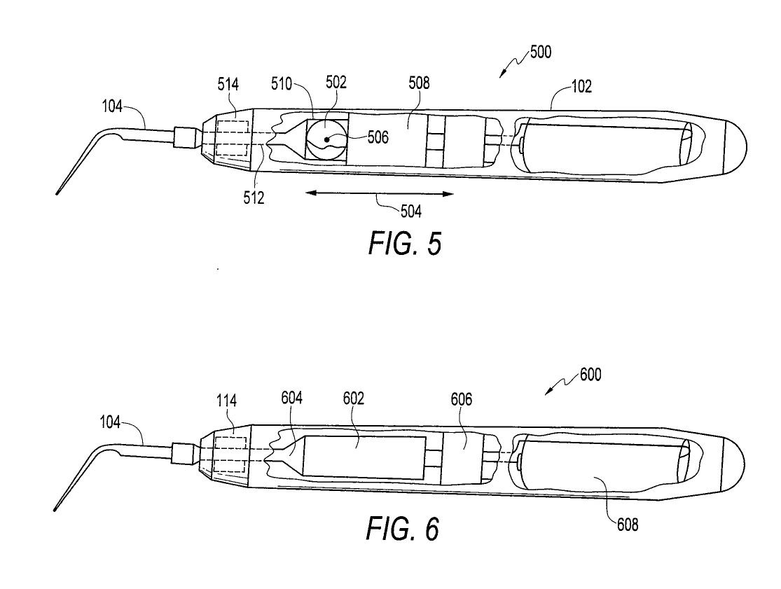

FIG. 5 shows a cutaway view of another embodiment of the invention. As illustrated, the FIG. 5 instrument 500 includes a housing 102, and a scaler tip 104. In the FIG. 5 embodiment, the axis of rotation of an elliptical load 502 is oriented transversely with respect to a longitudinal axis 504 of the housing 102. Accordingly, the axis of rotation 506 of the elliptical load 502 is oriented perpendicular to the surface of the page.

This orientation of the axis of rotation 506 is achieved, for example, by coupling an output shaft of a rotary electric motor 508 to a mechanical input of a gearbox 510. In an exemplary embodiment, the gearbox 510 includes two bevel gears oriented at right angles to one another. The first of the two bevel gears is coupled to the output shaft of the electric motor and the second of the two bevel gears is coupled to the output shaft of the gearbox, and hence to the eccentric load 502. The two bevel gears include respective teeth that mesh in rotation to transmit mechanical energy from the motor 508 to the eccentric load 502. The bevel gears may be formed on any suitable material such as a metallic composition including, for example, stainless steel, titanium, titanium alloys such as nickel-titanium and titanium-aluminum-vanadium alloys; aluminum, aluminum alloys; tungsten carbide alloys and combinations thereof. Alternative materials for the bevel gears include reinforced or unreinforced polymers such as, for example, polyamide (nylon); ultrahigh molecular weight polyethylene (UHMWP); Polyacetyl (Delrin); Polyaramid (Kevlar); ULTEM®, which is an amorphous thermoplastic polyetherimide, Xenoy® resin, which is a composite of polycarbonate and polybutyleneterephthalate, Lexan® plastic, which is a copolymer of polycarbonate and isophthalate terephthalate resorcinol resin (all available from GE Plastics); liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference) or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used.

Generally, polymeric materials or composites having high temperature resistance are suitable.

In operation, the rotation of the eccentric load 502 causes increased oscillation of the scaler tip 104 along the longitudinal axis 504 of the instrument 500, as compared with the oscillation produced by the arrangement of the FIG. 2 instrument 100.

In a further aspect of the invention, these oscillations may be transmitted from the housing of the gearbox 510 to the scaler tip 104 through a coupling member 512. The characteristics of the coupling member 512, including its mass, shape and rigidity, may be selected to optimize resonant response of the system as a whole. The coupling member 512 may be supported within the housing 102 by a supporting member 514. The supporting member 514 may be, for example, a substantially rigid bushing having a bore through which the coupling member 512 is adapted to slide. In an alternative embodiment, the supporting member 514 may include an elastic member adapted to flexibly support the coupling member 512.

FIG. 6 shows a cutaway view of an active dental instrument 600. The active dental instrument 600 includes a linear vibration device 602 according to a further embodiment of the invention. The linear vibration device 602 is adapted to linearly activate a coupling member 604 in response to a periodically varying electrical signal from an electrical control circuit 606. The electrical control circuit 606 is electrically coupled to linear vibration device 602 and to a source of electrical power such as a battery 608. The linear vibration device 602 may include piezo-electric device, and electromagnetic solenoid device, a capacitive transducer device, or a linear motor device such as a linear stepper motor.

In various aspects, the active instrument 600 may include a removable pick 104. This allows a single housing and its contents to provide oscillation to a variety of tips of different configurations. The removable pick may be fixed to the active instrument 600 with, for example, a threaded coupling or a bayonet mount.

In a further aspect, the energy storage reservoir may include a removable battery such as a carbon zinc battery or an alkaline battery. A non-removable rechargeable battery may also be used. An appropriate battery such as, for example, a Nickel Metal Hydride battery or a Nickel Cadmium battery may be selected according to the characteristics and requirements of a particular active instrument system.

In a further aspect of the invention, the instrument may include a battery charging circuit adapted to receive electrical energy from an external electrical energy source. Accordingly the active instrument may be coupled to a source of household voltage on an as-required basis, and the battery charging circuit then provides an appropriate charging current to the re-chargeable battery of the active instrument.

According to another embodiment, the invention includes electrical fuel cell and a fuel storage reservoir. The technology of fuel cells is advancing, and it is expected that fuel cells appropriate to inclusion in an active instrument of the invention will be available in the reasonably near future.

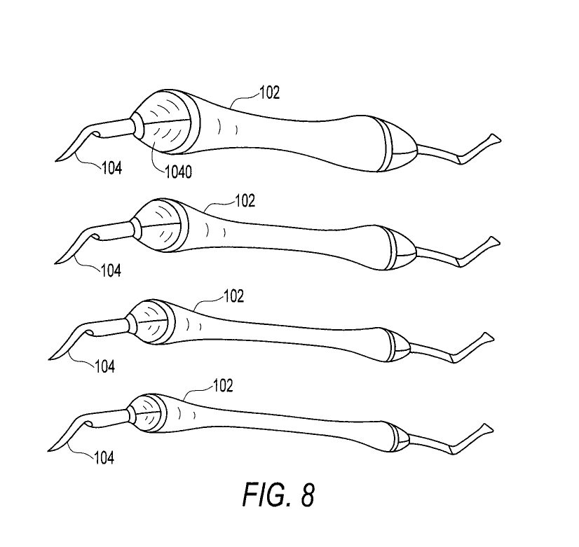

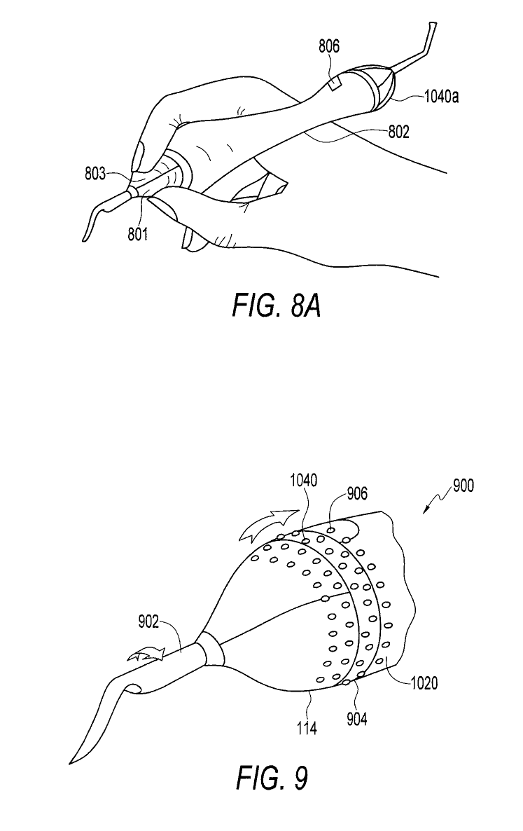

In a further aspect of the invention, the vibrations of the vibration mechanism (shown as 206 in FIG. 3, for example) are found, surprisingly, to provide a soothing effect to the hand of the dental professional employing the active instrument. Accordingly, the present invention includes an ergonomically advantageous dental instrument. These ergonomic advantages may be amplified by including additional features such as various handle diameters and triangular grips in the housing (eg. 102 of FIG. 8) in various embodiments of the invention.

The dental instruments used today all have handles or grasping portions that are of approximately the same diameter. This is true not only for one type of instruments, but for different instruments as well. Repetitive use of the instruments during the day causes repetitive stress to the hands, wrists, and elbows. This can lead to carpal tunnel syndrome (CTS) and cumulative trauma disorder (CTD) among dental hygienists, dentists and other dental professionals.

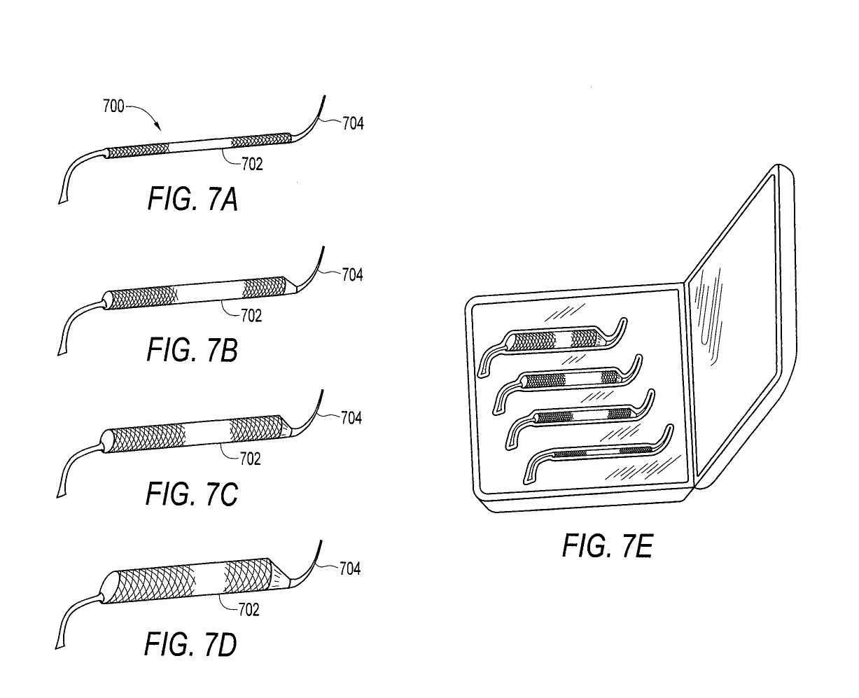

The present invention also includes sets of identical or different instruments, as shown in FIGS. 7a-e and 8, having handles made with varying diameters for grasping, designed to be used interchangeably throughout the day, thus cutting down on the repetitive grasping action through the change of grasp. Therefore, even if a dental professional uses the same type of instrument throughout the day, the hands, wrists and elbows may experience varying rather than repetitive action because the positioning of the hands, wrists and elbows are interchanging throughout the day.

The dental instrument includes an elongated housing 102, as shown in FIG. 8, having an interior that may be solid, hollow or partially solid. The elongated housing 102 has a distal end and a proximal end. A portion of the housing 102 may serve as a handle for grasping by the dental professional. The distal end has a dental tip 104 extending therefrom, and permanently or removably connected to the distal end of the housing 102.

The handles may further be ergonomically designed, as exemplified in FIG. 8. The details of instruments having varying diameters are described in a provisional application, “Dental Instruments with Stress Relief”, application No. 60/624,840; and a copending U.S. patent application Ser. No. 11/______, to be concurrently filed; the contents of both are incorporated herein by reference.

Furthermore, the cone-shaped portion 114, as shown in FIGS. 2, 4a, 6 and 9, may be rotatable wherein such rotation also rotates the dental tip so that the tip may be easily repositioned without being taken out of the patient's mouth.

The mechanism for rotation is similar to that described in the patent application U.S. Ser. No. 10/735,050, incorporated herein by reference.

In one embodiment, the cone-shaped portion may be integrally constructed as part of the handle or it may be constructed separately, by either molding, brazing, threadably connected or any other type of attachment to attach the tip 104 onto either the distal or the proximal end of the handle.

FIGS. 7a-d show a set of dental instruments, such as a dental scaler 700, according to one embodiment of the invention. As shown, each of the instruments includes a handle portion 702 and a tooth contacting portion 704. In the illustrated embodiment, the tooth contacting portion 704 is a scaler tip.

The handle portion 702 is cylindrical and may be of a solid core or a hollow core, having a distal end and a proximal end. As an illustration, the diameters of the handles vary from FIG. 7a to 7d. In other embodiments, a series with different numbers of handles with varying diameters or different instruments is contemplated. The sets of identical instruments made with varying diameters for grasping, may cut down on the repetitive action, as noted above.

The handle may be tapered toward either the distal end or the proximal end or both, as exemplified, and extending from the tapered end or ends are the dental tips adapted to be used on a patient's teeth or tooth.

The dental tip may be a scaler 704, as shown, or any other adapted to be fitted into a handheld instrument of the present invention, for example, a reamer, an endodontic file, a dental file or bur.

As noted, the dental tip may be present on both the distal end and the proximal end of the instrument, as shown (not shown) or it may be present on only one end with a different tool at the other end, as exemplified in FIGS. 7a-d.

The tapered portion 114, as shown in FIG. 9, may be integrally constructed as part of the handle or it may be constructed separately, by either molding, brazing, threadably connected or any other type of attachment to attach the tip 104 onto either the distal or the proximal end of the handle.

The tapered portion 114 may further be a cone-shaped portion having a hollow interior, as shown in FIG. 9.

The handle may be made of metal or plastic. The cone shaped portion or tapered portion may be made of the same or different material from the rest of the handle. A suitable metal may include, for example, those discussed above with regard to the gear. More for example, the materials are stainless steel and titanium alloys. These also, for example, have good flexibility.

A suitable non-metal may include a polymeric material, such as high temperature plastics including those mentioned above in relationship to the gear.

For example, bumps and/or striations (for example, 1040 as shown in FIG. 8 or 9) and/or other means may be formed on the gripping portion of the handle for better non-slip grip.

In some embodiments, instead of bumps and striations, the handle may also be made with a hand grip 1040a, as exemplified in FIG. 8a, which may be a sleeve-type construction for fitting over a portion of the handle to facilitate the gripping of the instrument during use, as also illustrated in FIG. 8a. In the embodiment as shown in FIG. 3, the hand grip 103, is present over a large portion of the handle 102. Such hand grips are generally resilient and of a high temperature resin suitable for autoclaving or heat sterilization process, including those polymers and composites described above that are suitable for the construction of the polymeric tips. In fact, any high temperature resin that can withstand autoclaving may be used.

As noted, the set of instruments shown in FIGS. 7a-d are identical, except for the diameters of the handles. This is also illustrated in FIG. 8 a-d, where the handles are of ergonomic design. The identical instruments with varying diameter handles may be used interchangeably throughout the day. Combining the varying diameters with the more ergonomically designed handles, the handles can go a long way to relieving stress to the hands, wrists and elbows of dental professionals.

The handle may be in the triangular shape, as shown in FIG. 8a, with a mid-section of a smaller circumferential distance than the gripping areas when the tip extends from on both ends. It may also be rounded in the mid-section. Both of these configurations may also be formed with bumps or striations, for example, as exemplified in FIG. 9 as 1040, about the grasping areas to facilitate grasping.

According to one aspect of the invention, as shown in FIGS. 3 and 8a, a vibrational mechanism may be included within the handle portion 102 and 802. The vibrational mechanism is adapted to induce oscillatory vibrations of an outer surface 101 of the handle 102, or a portion thereof 802. The oscillatory vibrations may include a variety of oscillatory modes including flexural and elastic linear modes and rotational modes. According to one embodiment of the invention, the instrument includes a resilient material 103 disposed on the outer surface 101 of the handle 102 (or 803 on the outer surface 801 in FIG. 8a) to work as a hand grip, as described above. The resilient material 103 or 803 serves to cushion the grip of the dental professional during application of the instrument. According one aspect, the invention includes a switching device 106 or 806 supported by the handle portion 102 or 802, respectively. The switching device 106 or 806 allows a user to activate, and deactivate, the vibrational mechanism disposed within the handle portion 102 or 806.

The hand grip 103 or 1040a may be fabricated using thermoplastic elastomers such as SANTOPRENE® available from the Monsanto Company, or those used in the construction of some tips, or any other suitable material, as mentioned before. The hand grip 103 or 1040a may be formed through injection molding in some embodiments. In other embodiments, the hand grip 103 or 1040a may be a one-piece construction. In still other embodiments, multi-piece hand grips may be used. By way of an example, a two-piece handgrip may be ultrasonically welded together over the handle 102 or 802. The hand grip 103 or 1040a may have a generally cylindrical shape, as shown in FIG. 3, or may shape like a pistol, as shown in FIG. 11 as 1120.

The hand grip or resilient material may also be either a natural or synthetic rubber. Synthetic rubbers may be, for example, elastomeric materials and may include, but not limited to, various copolymers or block copolymers (Kratons®) available from Kraton Polymers such as styrene-butadiene rubber or styrene isoprene rubber, EPDM (ethylene propylene diene monomer) rubber, nitrile (acrylonitrile butadiene) rubber, latex rubber and the like. Foam materials may be closed cell foams or open cell foams, and may include, but is not limited to, a polyolefin foam such as a polyethylene foam, a polypropylene foam, and a polybutylene foam; a polystyrene foam; a polyurethane foam; any elastomeric foam made from any elastomeric or rubber material mentioned above.

FIG. 9 shows an active instrument 900 having a rotatable tip 902. Such a rotatable tip 902 may also be used in each of the instruments shown above. The tip 902 is fixedly or removably coupled to a collar or rotator head 904 of the tapered portion 114. Rotation of the collar or rotator head 904 also rotates the dental tip 902 so that the tip may be easily repositioned without being taken out of the patient's mouth. A detent mechanism prevents rotation of the collar and tip when such rotation is not desired. The detent mechanism may be released to allow rotation by, for example, pressing a release button 906. The mechanism for rotation is similar to that described in the patent application U.S. Ser. No. 10/735,050, incorporated herein by reference.

The cone-portion or tapered portion 114, if removable, is, for example, made of a plastic material even if the rest of the handle is made of a metal or metal alloy.

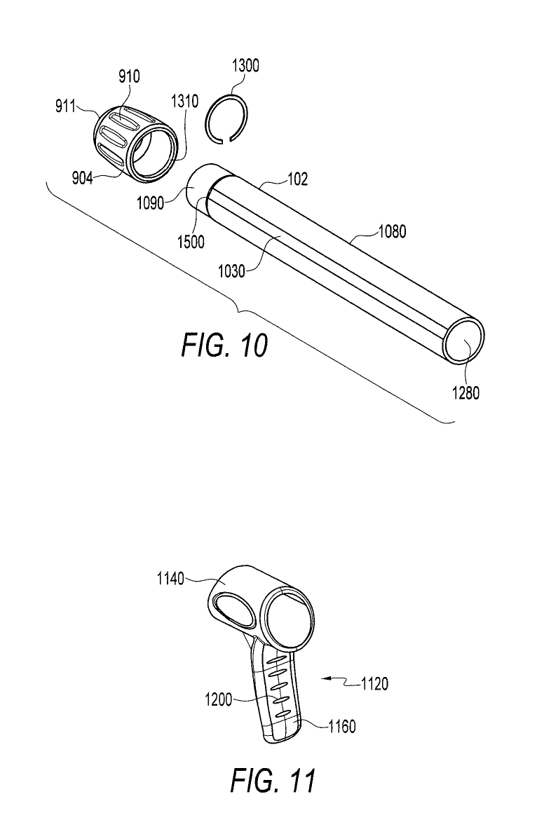

As shown in FIGS. 9 and 10, the rotator head 904 located at a distal end of the handpiece 900 is rotatably coupled to the rest of the handpiece 900. The rotator head 904 may have a generally cylindrical shape, a hollow interior, and an opening at each end of the interior, which is used to receive the distal end of the body 102 at one end and a dental tip 902 at the other end. For example, at its distal end, the rotator head 904 has formed thereon an opening 911 for receiving a tip 902.

The rotator head 904 may have formed around its outer peripheral surface a plurality of indentations 910. Each indentation 910 may have an elongated elliptical (or rectangular) shape with its major axis in the direction parallel to the central axis of the handpiece 900. The indentations 910 facilitate grasping of the rotator head 904 by a dental practitioner to rotate it, for example, with respect to the body 102 (e.g., using only one hand). In other embodiments, the rotator head 904 may have a number of protrusions formed thereon instead of the indentations.

The body 102 has formed thereon a pair of grooves 1030 that are equidistant from the top and traverse substantially the whole length of the body 102. The grooves 1030 may be used to mount a hand grip 1120, as shown in FIG. 11, on the handpiece 900. The body 102 may have also formed thereon at its bottom near the distal end of the body 102, a plurality of substantially evenly spaced slots 1080 that may be used to keep the hand grip 1120 from moving in the direction of the axis of the handpiece 900. The body 102 may also have formed thereon at its bottom near the proximal end a groove (not shown) that is co-linear to the slots 1080. The groove may engage the hand grip 1120 together with the grooves 1030 to keep the hand grip 1120 from rotating about the central axis of the handpiece 900.

The hand grip 1120 has an engagement portion 1140, which has a generally cylindrical shape and a hollow interior, as exemplified in FIG. 11. The engagement portion 1140 is adapted to be slipped onto the body 102, similar to a sleeve, and engages the body 102 such that the engagement portion envelopes a portion of the body 102. The engagement portion may have formed thereon a resilient cantilever portion (not shown), which may be used to engage one of the slots 1080 on the body 102. The engagement portion 1140 may have attached to its bottom surface a handle 1160, which may be grasped by a dental practitioner to hold the handpiece 900 during dental procedures. The handle 1160 may also facilitate rotating of the rotator head 904 using one hand. The handle 1160 may have formed on its back surface a plurality of indentations or protrusions 1200, which are used to facilitate grasping by a dental practitioner.

Referring now to FIGS. 9 and 10, the handpiece 900 further includes a retainer ring 1300, which may be made of metal, for example any of those mentioned above. The retainer ring 1300 may be substantially circular in shape, but does not quite form a complete circle. The retainer ring 1300 may be flexible (resilient) and works as a spring in that the ends that are not connected together may be brought closer together by applying pressure, and separate when the pressure is removed.

The rotator head 904 may have formed on the inner surface near its proximal end a circular groove 1310, as exemplified in FIG. 10, that may be used to engage the retainer ring 1300. The retainer ring 1300 may be installed in the circular groove 1310, for example, by applying pressure on the retainer ring 1300 to compress it, and releasing it once the retainer ring 1300 has been aligned with the groove 1310. Upon installation, the retainer ring 1300 is locked to and is fixed with respect to the rotator head 904.

After locking the retainer ring 1300 to the groove 1310, the rotator head 904 is coupled with the body 1020 by receiving the distal end of the body 102 into the rotator head opening at its proximal end. The body 102 may have formed at its distal end an engagement portion 1090, which has a radius that is smaller than the radius of the rest of the body 102. At a joint between the engagement portion 1090 and the rest of the body 102 may be formed a circular groove 1500 on an outer surface of the engagement portion 1030. When the engagement portion 1090 is inserted into the rotator head 904, the retainer ring rotatably engages the groove 1500 such that the rotator head 904 is rotatably coupled to the body 102. In other embodiments, the retaining ring may be fixedly coupled to the body 1020 and rotatably coupled to the rotator head 904.

The hand grips may also be made with varying diameters for grasping, designed to be used interchangeably throughout the day, coupled with more ergonomically designed handles. The details of varying diameters are described in a U.S. provisional application No. 60/624,840 entitled, “Dental Instruments With Stress Relief” filed on Nov. 3, 2004; and a copending U.S. patent application, “Dental Instruments with Stress Relief”, application Ser. No. 11/______, to be filed on the same day; the contents of both are incorporated herein by reference.

The tip may have a flexible and durable coating 1010a coated thereon, such that the coated tip may be bent to the desired configuration. This bend may also be introduced before coating and may be present at a location coated with the DLC coating. The coating may also be present on other parts of the handle.

Heat tends to be generated about the tip during use due to frictional forces. Therefore, a coating having high lubricity can generally decrease the frictional forces and hence the heat generated, leading to reduced patient discomfort during the dental process. Suitable coatings that have high lubricity include diamond-like carbon (DLC) coatings including at least about 5 atomic percent of hydrogen. The details of durable coatings is described in a U.S. provisional patent application Ser. No. 60/612,283, entitled “Dental Tool Having A Durable Coating” filed on Sep. 21, 2004; and U.S. patent application Ser. No. 11/______, entitled “Dental Tool Having A Durable Coating” to be filed concurrently; the contents of both are hereby incorporated by reference.

Suitable coatings may include DLC coatings having, for example, between about 5 atomic percent hydrogen to about 45 atomic percent, and more for example, from about 10 to about 30 atomic percent hydrogen. Generally, higher percentages of hydrogen may be used for more flexible tips, and lower percentages of hydrogen for tips with less flexibility. Those with higher percentage of hydrogen will also be of lower density and softer than those with lower amounts of hydrogen. In addition, smaller amounts of other elements may also be present. For example, the DLCs may include up to about 5 atomic percent of oxygen or nitrogen as well as small quantities of other materials.

As noted above, the DLC coatings, though hard, may be flexible so that the flexural properties of the tip substrate will not be significantly altered by the coatings. The combined effect can be a longer lasting abrading surface.

Generally, because the DLC coatings are flexible and lubricious, a substantially uniform thickness may be achieved even at thin coatings of, for example, about 20 nm. A DLC coating can be applied substantially uniformly over a desired section of the substrate. More for example, a uniform coating can be a coating in which the thickness at all points along the substrate varies by, for example, less than about 50%, and more for example, by less than about 10% relative to the average coating thickness.

Alternatively, the DLC coating may also be applied non-uniformly so that the thickness of the coating can vary at different regions of the working surface, if desired. In some embodiments, the area with the maximum coating thickness can be no more than a factor of about two (2) thicker than the area with the minimum coating thickness. A non-uniform coating thickness can accomplish a variety of goals that a uniform coating cannot, for example, simplifying deposition, and/or adding mechanical stability to stress points of the abrading surfaces or the tip. Generally, because the DLC coatings are flexible and lubricious, a substantially uniform thickness may be achieved even at thin coatings of, for example, about 20 nm.

The DLC coating may also be thicker at portions of the tip that maybe expected to be subjected to high stress or wear to provide increased wear resistance. For example, the extended portion in the bend may have a thicker coating than the compressed portion, to keep the shape of the bend. In addition, a chosen deposition approach may inherently produce a DLC coating that is non-uniform in thickness unless significant efforts are made to reduce the non-uniformity.

The composition of a DLC coating may also be either uniform or different at different regions of the coating. For example, regions that are subject to more stress may have one particular composition while other portions of the coating can be formed with other dopants, for example, to vary the flexibility. Similarly, the DLC coating may have layers of diamond-like carbon with different compositions.

In one example, the instrument may be constructed with the tip and the hand grip already assembled prior to coating the tip with a DLC coating. This process is possible because the low coating temperature of the coating processes approximates that of autoclaving. This gives flexibility in the assembly of the instrument.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1-31. (canceled)

32. A tooth cleaning system comprises:
a handle portion with elongated housing having at least a partially hollow interior;
a tooth contacting portion attached to said handle;
a vibratory transducer positioned and supported in said housing; and
a power supply unit.

33. The tooth cleaning system of claim 32 wherein said tooth contacting portion comprises a dental tip which is removably attached to the housing

34. The tooth cleaning system of claim 32 wherein said vibratory transducer comprises a small motor for rotating an eccentric weight to cause a vibration in the instrument.

35. The tooth cleaning system of claim 32 wherein said power supply unit is selected from the group consisting of a battery, a fuel cell, a solar cell and combinations thereof.

36. The tooth cleaning system of claim 32 further comprising an anti-rotation means for preventing said vibratory transducer from rotating relative to said housing.

37. The tooth cleaning system of claim 33 wherein said dental tip is selected from the group consisting of a dental scalar tip, an endodontic file, a dental file, a reamer, and a dental bur.
